(19) United States
(12) Patent Application Publication
(10) Pub. No.: US 2015/0332606 A1
(43) Pub. Date: Nov. 19, 2015

(54) REAL-TIME, INTERACTIVE, REMOTE ATHLETIC TRAINING

(71) Applicant: Jesse Orosco, Valley Center, CA (US)

(72) Inventor: Jesse Orosco, Valley Center, CA (US)

(21) Appl. No.: 14/710,853

(22) Filed: May 13, 2015

Related U.S. Application Data
(60) Provisional application No. 61/992,423, filed on May 13, 2014.

(51) Int. Cl. G09B 19/00

(52) U.S. Cl. CPC G09B 19/0038

(57) ABSTRACT

An interactive athletic training system is described. The system provides real-time interaction among a set of student-users and a set of instructor-users. The interaction includes capture and provision of multimedia content, two-way audio and/or messaging communications, and sharing of existing content. Data related to each interactive session is stored and made accessible to the users for subsequent review, analysis, and/or feedback.

### CROSS-REFERENCE TO RELATED APPLICATIONS

This application claims priority to U.S. Provisional Patent Application Ser. No. 61/992,423, filed on May 13, 2014.

### BACKGROUND

Current athletic training and instruction utilizes static media (e.g., previously-recorded video, text, etc.). Such static media is not tailored to the needs of each student. In addition, such non-interactive media does not provide feedback to a student.

In-person instruction requires students and instructors to be located within a reasonable proximity. In addition, such arrangements include additional travel and setup time and do not allow a student to review previous lessons or lessons involving other students and/or instructors.

Therefore, there exists a need for a training environment that allows users from remote areas to interact in real-time and to access information related to other training sessions.

### SUMMARY

Some embodiments provide ways for instructors and students to interact. Such interactions may be focused on athletic training and instruction. Each user (e.g., student, instructor, etc.) may be able to access a system of some embodiments using a user device such as a smartphone.

Students may be able to select coaches based on various criteria collected and provided by the system of some embodiments. For instance, each instructor or coach may be associated with a biography listing the qualifications and experience of the coach, collections of user ratings and comments related to the coach, etc. The system may likewise allow instructors to review student bios that may include information such as the student's age, ability level, training goals, ratings by other coaches, etc.

Some embodiments may allow students and instructors to schedule lessons. For instance, a coach may provide a calendar listing availability over a certain time period. A student may select that instructor and be provided with information regarding the availability. The student may then be able to select a convenient lesson time and duration. In some embodiments, the users may be provided with notifications or reminders of an upcoming lesson.

During a lesson, each user may be able to interact with the other session participants.

Such interaction may include, for instance, sharing of video data among users. In one example scenario, a student may capture video of the student performing an action or technique. The captured video may be provided to an instructor in real-time for review and analysis. The instructor may provide feedback in various ways (e.g., audio feedback, video capture, provision of multimedia such as instructional videos, etc.).

Data for each lesson may be stored by the system. Such data may include the captured video (and/or other) data, notes, feedback, etc. provided by the instructor, and/or other relevant data (e.g., time of day, weather conditions, training goals, etc.).

Some embodiments may allow users to review stored lesson data. For instance, a student may watch a lesson to better understand or reinforce the instruction provided. As another example, a user may capture data and send the data to an instructor for offline analysis and review.

The preceding Brief Summary is intended to serve as a brief introduction to various features of some exemplary embodiments. Other embodiments may be implemented in other specific forms without departing from the spirit of the disclosure.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates a schematic block diagram of a hardware system according to an exemplary embodiment of the invention;

FIG. 2 illustrates a schematic block diagram of a software system according to an exemplary embodiment of the invention;

FIG. 3 illustrates a schematic block diagram of an example system configuration used by some embodiments to provide a lesson;

FIG. 4 illustrates a flow chart of a process used by some embodiments to provide ways for a user to interact with the system;

FIG. 5 illustrates a flow chart of a process used by some embodiments to conduct a lesson;

FIG. 6 illustrates a flow chart of a process used by some embodiments to perform a user login;

FIG. 7 illustrates a flow chart of a process used by some embodiments to interact with a student-user;

FIG. 8 illustrates a flow chart of a process used by some embodiments to interact with an instructor-user;

FIG. 9 illustrates a flow chart of a process used by some embodiments to interact with an administrator-user; and

FIG. 10 illustrates a schematic block diagram of a computer system with which some embodiments may be implemented.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various inventive features are described below that can each be used independently of one another or in combination with other features. Broadly, some embodiments of the present invention generally provide a way for students and instructors to conduct real-time, interactive lessons from distinct locations. Some embodiments may receive a selection of an instructor from a set of available instructors, a lesion time and duration, and/or other appropriate attributes. In addition some embodiments may provide an interactive lesson environment to each instructor and student.

Such interactive lessons may include at least one student and at least one instructor. A student may use a user device such as a smartphone to capture video of the student performing some action (e.g., throwing a baseball, fielding ground balls, swinging a bat). The video may be made available to the instructor who may then be able to provide feedback. Such feedback may include audio feedback (e.g., a description of different technique or approach), video feedback (e.g., graphical elements such as added to the video to highlight elements of the student's performance, demonstration of proper technique, etc.), text feedback (e.g., written instructions, messages, etc.), and/or other appropriate feedback.

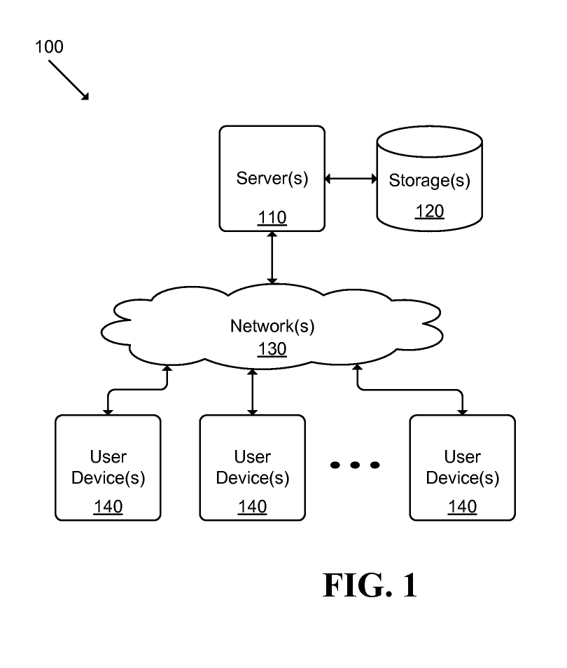

FIG. 1 illustrates a schematic block diagram of a hardware system 100 according to an exemplary embodiment of the invention. As shown, the system may include one or more servers 110, a set of storages 120, one or more networks 130, and multiple sets of user devices 140.

Each server 110 may be an appropriate computing device that is able to process instructions and/or manipulate data. The server(s) may be implemented using various specific configurations of devices. The associated set of storages 120 may be accessible to the servers (e.g., by direct connection, across one or more networks, etc.) and may be able to provide, receive, and/or store data and/or instructions.

The networks 130 may include various local or distributed networks (e.g., Ethernet networks, wireless networks, the Internet, cellular networks, etc.). The networks may allow communication among the servers 110 and user devices 140. Such communication may include various types of messages and/or data (e.g., multimedia data). The networks 130 may be provided and/or implemented using various sets of physical devices that may be deployed across various physical locations.

Each user device 140 may be an electronic device that may allow a user to access one or more communication networks 130 and/or which may include various user interface elements. Examples of user devices 140 include smartphones, tablets, personal computers (PCs), etc. Such devices may include user interface elements such as touchscreens, displays, buttons, keyboards, keypads, cameras, microphones, audio outputs, speakers, and/or other appropriate elements. Such elements may allow the device to receive information from a user or provide information to the user.

In addition, each user device may be able to interact with various external devices. Such devices may include, for instance, external speakers, cameras, displays, etc.

Although system 100 has been described with reference to various details, one of ordinary skill in the art will recognize that such a system may be implemented in various different ways without departing from the spirit of the invention. For instance, various additional elements may be included and/or various elements may be eliminated.

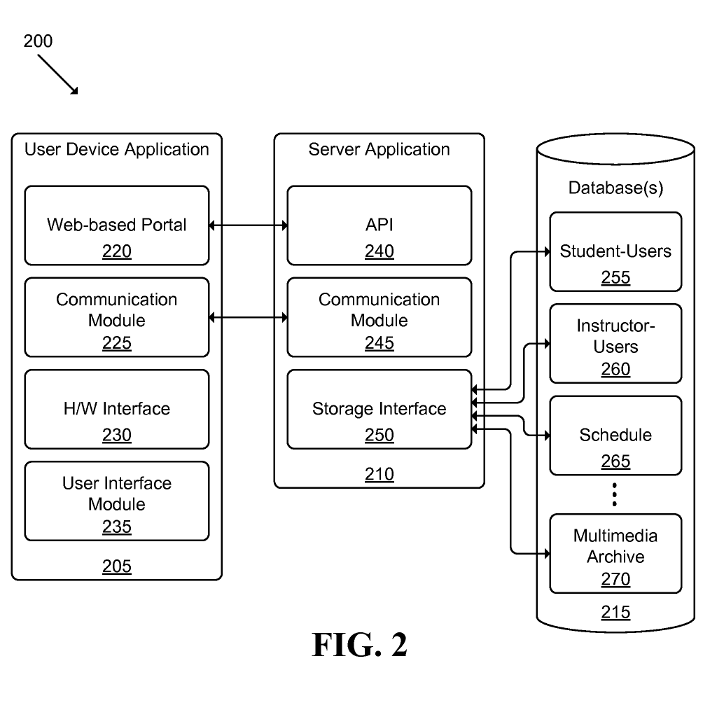

FIG. 2 illustrates a schematic block diagram of a software system 200 according to an exemplary embodiment of the invention. As shown, the system may include a user device application 205, a server application 210, and a set of databases 215.

The user device application 205 (or client-side application) may be implemented by a user device such as that described above in reference to system 100. The user device application may include a web-based portal 220, a communication module 225, a hardware interface 230, and a user interface module 235.

The web-based 220 portal may be a web browser or other portal available to the user device and may be able to access various external resources (e.g., resources provided by the server application, resources provided by third-party applications, etc.). In some embodiments, a user may access the web-based portal by entering a uniform resource locator (URL) that is associated with the system of some embodiments.

The communication module 225 may allow the user device application 205 to communicate with the server application 210 (and/or other external resources). Such a module 225 may utilize various pathways available to the user device (e.g., a wireless network connection, a cellular network connection, etc.).

The hardware interface 230 may allow the user device application 205 to utilize or otherwise interact with various hardware elements of the user device (e.g., a display screen or touchscreen, a microphone, speakers or other audio output, camera, storage, etc.).

The user interface module 235 may allow the user device application 205 to recognize and/or interpret various user inputs and/or to provide appropriate outputs to the user. For instance, the user interface module 235 may decipher data received via a touchscreen in order to identify user commands. As another example, the user interface module may present multimedia data to the user.

The server application 210 (or server-side application) may be implemented by a server device such as that described above in reference to system 100. The server application may include one or more application programming interfaces (APIs) 240, a communication module 245, and a storage interface 250.

The API 240 may allow a user device application 205 (e.g., via the web-based portal or the communication module) to interact with the server application 210. For instance, the API 240 may allow the user device application 205 to retrieve stored multimedia data.

The communication module 245 may allow the server application 210 to communicate with the user device application 205 (and/or other external resources). Such a module 245 may utilize various communication pathways available to the server (e.g., a wireless network connection, a cellular network connection, etc.).

The storage interface 250 may allow the server application 210 to store data to and/or receive data from the databases. Such a storage interface 250 may include one or more network connections, as appropriate.

The databases 215 may include instructions and/or data that may be utilized by various system elements. For instance, the databases may include data related to student-users 255 (e.g., sport, position, level, age, gender, etc.), data related to instructor-users 260 (e.g., sport, position, gender, location, specialties, experience, etc.), data related to scheduling 265 (e.g., time, duration and participants associated with a scheduled lesson, availability of instructors, etc.), and a multimedia archive 270 (e.g., video, audio, and/or other types of multimedia data associated with each lesson).

Although system 200 has been described with reference to various details, one of ordinary skill in the art will recognize that such a system may be implemented in various different ways without departing from the spirit of the invention. For instance, various additional elements may be included and/or various elements may be eliminated.

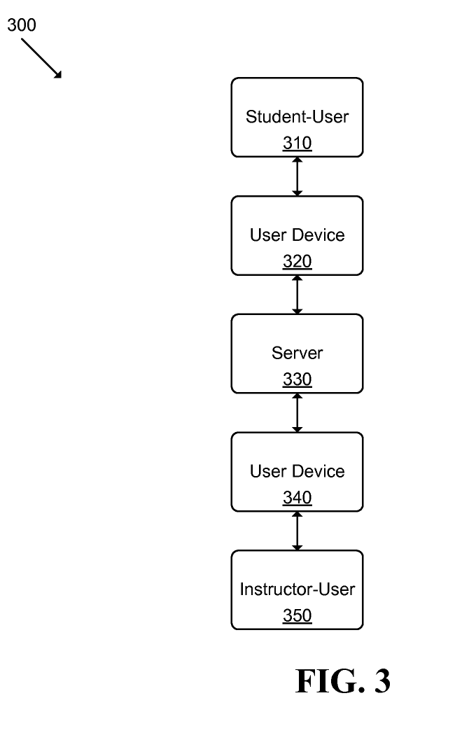

FIG. 3 illustrates a schematic block diagram of an example system configuration 300 used by some embodiments to provide a lesson. As shown, the system may include a student-user 310 with an associated user device 320, a server 330 (or other appropriate communication pathway), and a user device 340 associated with an instructor-user 350. Although this example includes one student and one instructor, multiple other participants may also be included using the same or additional user devices.

For instance, in some cases, a single instructor may interact with multiple students at a time (e.g., groups of students with similar age, skill level, etc.). In addition, other types of participants may be able to access a session (e.g., in addition to any students, a local coach may watch and/or participate in a session with a regional instructor). Different users (or types of users) may be provided with different access levels (e.g., view only, two-way communication, use of tools or features, etc.).

In some embodiments, the user devices 320 and 340 may communicate without intervention of the server 330 (e.g., by sending data among a set of user devices where each device executes a user device application of some embodiments). In some of these embodiments, either or both user devices 320 and/or 340 may also communicate with the server 330 (e.g., to store lesson data after a session is completed).

During an active lesson or session, the student-user 310 may set up the user device 320 to capture audio and video information. Other information may also be captured by some embodiments. For instance, sessions associated with running, rowing, or cycling may capture data including elevation, temperature, speed, etc.

The user device 320 may be manipulated by an associate of the student, mounted on a tripod or other support, or otherwise appropriately deployed such that the student 310 may capture data reflecting the performance of the student at some athletic endeavor. The captured data may be sent in real-time to the user device 340 associated with the instructor-user 350. The instructor-user may also use the associated user device 340 to capture audio, video and/or other information (e.g., the instructor may use a touchscreen or other appropriate input to draw on one or more video frames and add the information to captured video, the instructor may type notes on a keyboard and associate the notes with various multimedia items or portions thereof, etc.).

In addition, some embodiments may allow an instructor to associate multimedia content with the captured information. For instance, the instructor may include video of proper technique and the video may be displayed to the student before the student performs the technique.

Various communication pathways may be enabled via the system of some embodiments (e.g., messaging, voice over IP, etc.). In this way, the student 310 and instructor 350 may interact as desired during a live instructional session.

In some embodiments, an instructor may also provide instruction and/or feedback by capturing video data (or otherwise acquiring data) of the instructor (or another athlete or instructor) performing an athletic endeavor, demonstrating elements of proper technique, etc. Such data may then be provided to the student in real-time.

Different specific usage scenarios (or portions thereof) may also be implemented using various different sets of devices. For instance, a student may capture video and store the video via the server, an instructor may retrieve, also via the server, the captured video, and then provide feedback to the student by adding audio or graphical data to the captured video and then storing the updated content via the server where it may then be accessed by the student. As another example, captured multimedia may be provided to a set of instructors for feedback.

Although system 300 has been described with reference to various details, one of ordinary skill in the art will recognize that such a system may be implemented in various different ways without departing from the spirit of the invention. For instance, various additional elements may be included and/or various elements may be eliminated.

Each of the processes described below may be implemented using various combinations of elements, as appropriate. For instance, process operations may be performed at a user device by receiving data and/or instructions from a server, providing a user interface at the user device based at least partly on the received data, capturing data at the user device, and sending at least some of the captured data to the server. Some operations may be performed by either a user device or a server and a command or message based on each operation may be sent to the other device(s). Other operations may be performed solely by a user device or server, as appropriate.

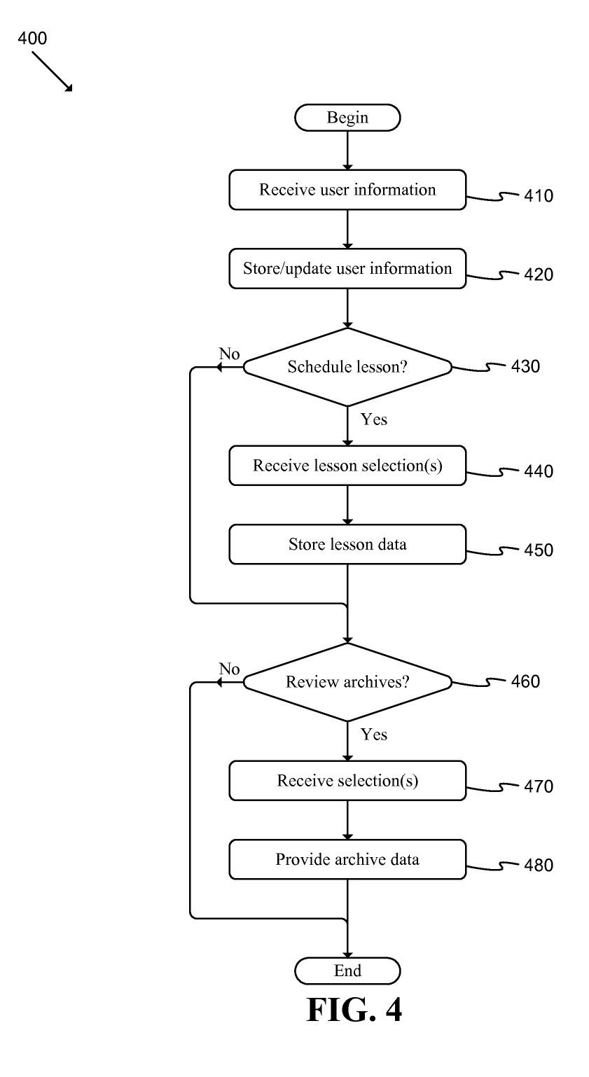

FIG. 4 illustrates a flow chart of a process 400 used by some embodiments to provide ways for a user to interact with the system. The process may be implemented using systems such as systems 100-300 described above. Such a process may begin, for example, when a user accesses a URL associated with some embodiments, or when a user launches a client-side application of some embodiments.

As shown, the process may receive (at 410) user information. Such information may include login information (e.g., a username and password), identifying information (e.g., name, geographic area, etc.), schedule information (e.g., availability, time zone, etc.), profile information (e.g., name, highest level of play, coaching credentials, specialties, etc.). Such information may also include feedback (e.g., rating of instructors by users, comments, etc.), messages (e.g., messages between a student and instructor, messages among sets of users, etc.), and/or other appropriate information. Different types of users may be able to provide different information (e.g., a student and instructor may provide distinct sets of information).

In addition to the information received above, the process may retrieve previously-entered information associated with a user and/or other available information (e.g., previous instructors, previous students, archived lessons, etc.). Some embodiments may allow users to compile a public profile that may limit access to some or all user information depending on various appropriate factors (e.g., residential address may be withheld from all other users, while information such as sport or credentials may be provided to all users, etc.).

The process may then store and/or update (at 420) information associated with the user, as appropriate.

Next, the process may determine (at 430) whether the user wishes to schedule a lesson. If the process determines that the user does wish to schedule a lesson, the process may receive (at 440) a set of lesson selections and store (at 450) the lesson data. Such lesson selections may include, for example, sport, position, lesson type, instructor, lesson time, lesson duration, etc. Different users may enter different sets of information (e.g., a student may make a set of selections including an instructor and the instructor may simply accept, decline or modify the student selections).

After storing (at 450) the lesson data or determining (at 430) that the user does not wish to schedule a lesson, the process may determine (at 460) whether the user wishes to review archives. Such archives may include, for instance, previous lessons associated with a student or instructor, publically available lessons (e.g., beginner pitching, fielding, hitting, etc.), and/or other system information (e.g., message threads, user reviews, etc.).

In some embodiments, the archives may include tags or identifying elements to allow users to identify sets of elements using various appropriate criteria (e.g., sport, instructor, student biography, etc.).

Next, the process may receive (at 470) a set of selections and provide (at 480) archive data based on the received selections. Such archive data may include video data, lesson data, etc.

After providing (at 480) the archive data or after determining (at 460) that the user does not wish to review archive data, the process may end.

One of ordinary skill in the art will recognize that process 400 may be implemented in various different ways without departing from the spirit of the invention. For instance, different embodiments may include different specific operations, eliminate various operations, merge or divide various operations, perform sets of operations iteratively, etc. In addition, the process may be performed as a set of sub-processes or included as part of a larger macro-process.

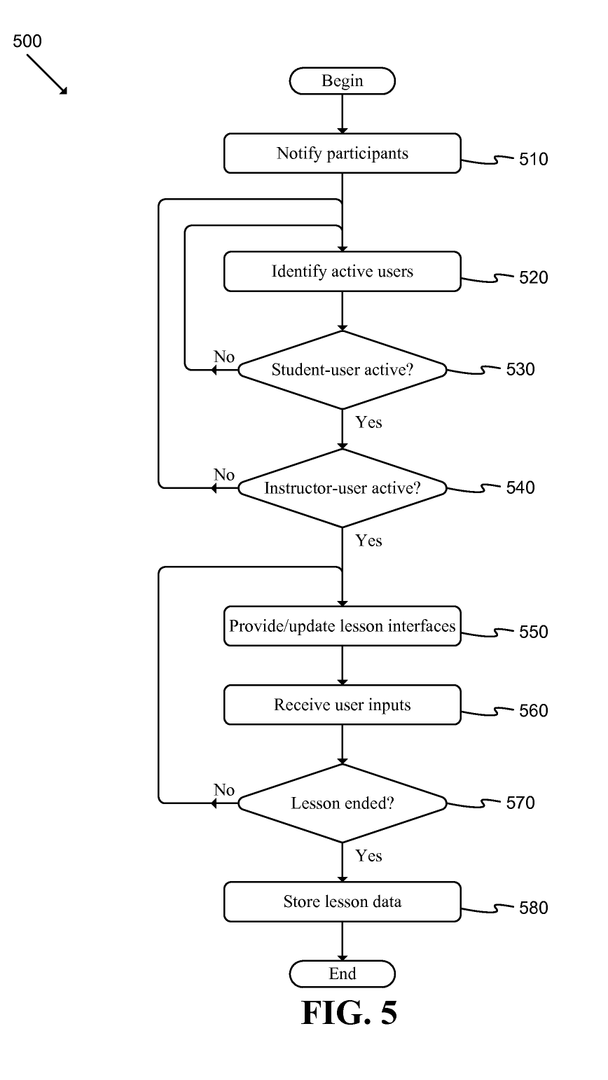

FIG. 5 illustrates a flow chart of a process 500 used by some embodiments to conduct a lesson. The process may be implemented using systems such as systems 100-300 described above. Such a process may begin, for instance, when a lesson is scheduled to begin.

The process may then notify (at 510) participants that the lesson is scheduled to begin. Such notifications may be sent in various appropriate ways (e.g., push notification, text message, email, via the client application user interface of some embodiments, etc.) and may be based at least partly on user preference.

Next, the process may iteratively identify (at 520) active users until the process determines (at 530 and 540) that all student-users and instructor-users associated with the lesson are active. Such determinations may be based at least partly on user status with a client application of some embodiments (e.g., by determining whether a client application responds to a prompt within an appropriate time).

If the process determines that all associated users (or all necessary users) are active, the process may then provide and/or update (at 550) a lesson interface to each user. Such interfaces may include, for instance, video display elements, text elements, graphical elements, input elements, etc. Updates may include providing updated content and/or modifying various display parameters such as window size, input options, etc.

Next, the process may receive (at 560) user inputs from the various users. Such inputs may include, for instance, video data from a student, audio feedback from an instructor, graphical or video data from the instructor, audio input from a parent or other interested party, etc.

The process may then determine (at 570) whether the lesson has ended (e.g., by determining whether any users are active). If the process determines (at 570) that the lesson has not ended, the process may update (at 550) the lesson interfaces and receive (at 560) user inputs until the process determines (at 570) that the lesson has ended. If the process determines that the lesson has ended, the process may store (at 580) lesson data (e.g., video data, feedback data, etc.) and then may end.

Stored lesson data may be made available to the student-user via the multimedia archive. In addition, in some embodiments lesson data may be made available to other users. For instance, a student-user may share previous lessons with a new instructor or a set of other specific users. As another example, an instructor may provide sample lessons to prospective students. As yet another example, an instructor may provide a set of lessons (associated with that instructor and/or other instructors) to a specific student (or set of students). In addition, such data may be made available to the public or to a set of registered users or some other appropriate set of users.

One of ordinary skill in the art will recognize that process 500 may be implemented in various different ways without departing from the spirit of the invention. For instance, different embodiments may include different specific operations, eliminate various operations, merge or divide various operations, perform sets of operations iteratively, etc. In addition, the process may be performed as a set of sub-processes or included as part of a larger macro-process.

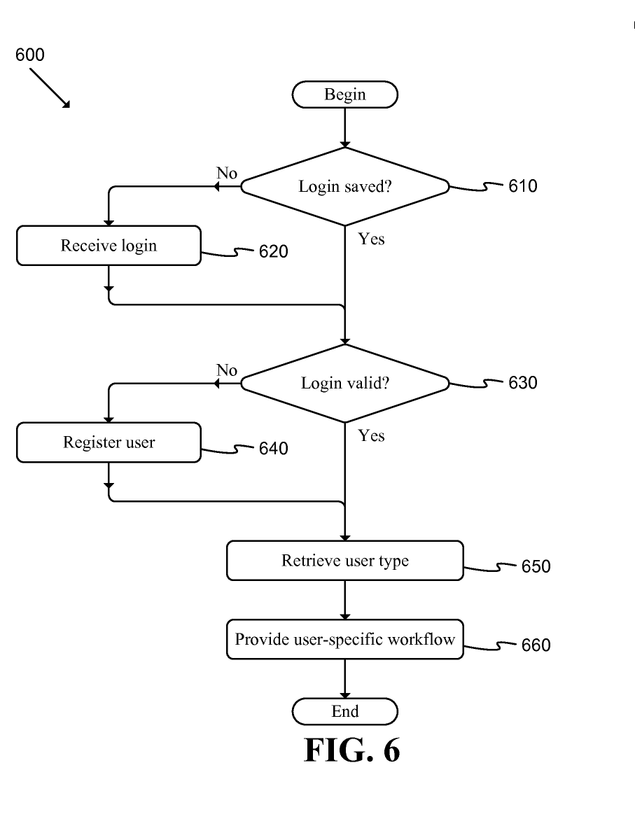

FIG. 6 illustrates a flow chart of a process used by some embodiments to perform a user login. The process may be implemented using systems such as systems 100-300 described above. Such a process may begin, for instance, when a user accesses a web portal of some embodiments or launches a client application of some embodiments.

As shown, the process may determine (at 610) whether a login has been saved. If the process determines that no login has been saved, the process may receive (at 620) login information. After receiving (at 620) the login information or after determining (at 610) that login information had been previously saved, the process may determine (at 630) whether the login is valid. Such a determination may be made in various appropriate ways (e.g., by comparing a user ID and password to previously-stored information).

If the process determines (at 630) that the login is invalid, the process may register (at 640) the user as a new user. Registration may include receiving and storing user information in a database for future use. Alternatively, the user may be provided with various options (e.g., password reset, hint, etc.).

After registering (at 640) the user or after determining (at 630) that the login information is valid, the process may retrieve (at 650) the user type (e.g., student, instructor, administrator, etc.) from a storage or service, provide (at 660) a user type-specific workflow and then may end.

One of ordinary skill in the art will recognize that process 600 may be implemented in various different ways without departing from the spirit of the invention. For instance, different embodiments may include different specific operations, eliminate various operations, merge or divide various operations, perform sets of operations iteratively, etc. In addition, the process may be performed as a set of sub-processes or included as part of a larger macro-process.

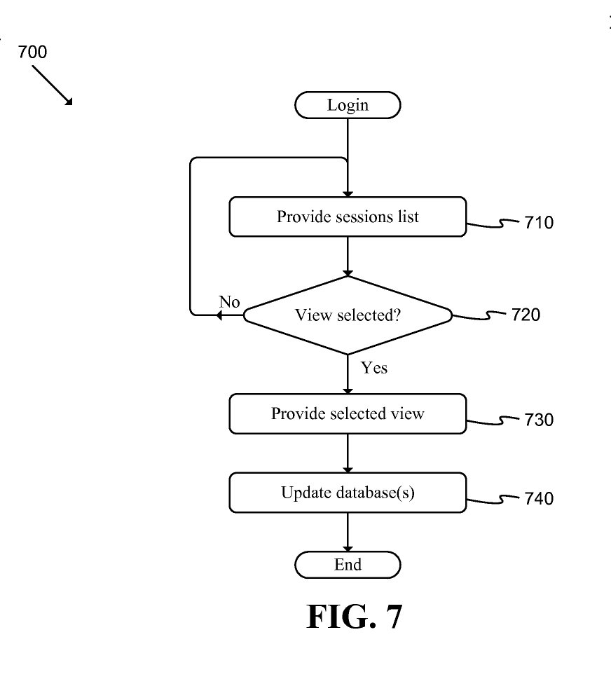

FIG. 7 illustrates a flow chart of a process used by some embodiments to interact with a student-user. The process may be implemented using systems such as systems 100-300 described above. The process is one example of a user type-specific workflow described above in reference to operation 660. The workflow may be associated with a student or instructor. Such a process may begin, for instance, after a login process has been completed.

If the user is a new user (e.g., during a first login), the process may perform a tutorial before proceeding.

As shown, the process may provide (at 710) a sessions list. Such a list may include various session views (e.g., details view, instructor bio, student bio, journal, booking or scheduling view, etc.). Various views may include different privilege levels depending the user or user type (e.g., a student-user may be able to edit a student bio associated with the user while an instructor-user would not be able to edit the student bio). Some elements may be edited by sets of users (e.g., a couch and player may be able to edit elements of a shared journal).

Various views may share data or resources with other views and/or databases. For instance, the session details view or coach bio view may interact with a messaging view that may further interact with an email or messaging service. As another example, the journal may be associated with a journal database. The booking view may interact with a scheduling service, a device calendar, push notification features (which may in turn interact with the session details view), etc.

Process 700 may determine (at 720) whether a view has been selected. If the process determines that a view has been selected, the process may provide (at 730) the selected view, update (at 740) any affected databases, and then may end.

One of ordinary skill in the art will recognize that process 700 may be implemented in various different ways without departing from the spirit of the invention. For instance, different embodiments may include different specific operations, eliminate various operations, merge or divide various operations, perform sets of operations iteratively, etc. In addition, the process may be performed as a set of sub-processes or included as part of a larger macro-process.

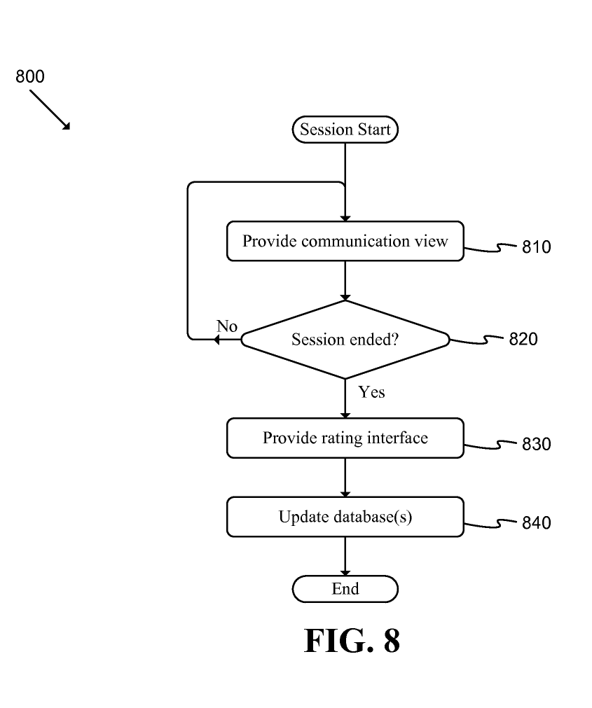

FIG. 8 illustrates a flow chart of a process used by some embodiments to interact with a coach-user. The process may be implemented using systems such as systems 100-300 described above. The process is one example of an interactive session. Such a process may begin, for instance, when all required users are available. Such a determination may be made by a process such as process 500 described above.

As shown, process 800 may provide (at 810) a communication view. Such a view may include two-way live video and/or other multimedia. Such a view may be implemented using one or more video services.

Next, the process may determine (at 820) whether the session has ended. Such a determination may be made based on various appropriate factors (e.g., user logoff, session duration reached, etc.).

If the process determines that the session has ended, the process may provide (at 830) a rating interface that may receive and store ratings associated with an instructor, student, lesson, etc.

In addition, some embodiments may allow users to report time charged, subtotal amounts, etc. The process may update (at 840) the appropriate databases (e.g., ratings database, lesson database, video storage, etc.) and then may end.

One of ordinary skill in the art will recognize that process 800 may be implemented in various different ways without departing from the spirit of the invention. For instance, different embodiments may include different specific operations, eliminate various operations, merge or divide various operations, perform sets of operations iteratively, etc. In addition, the process may be performed as a set of sub-processes or included as part of a larger macro-process.

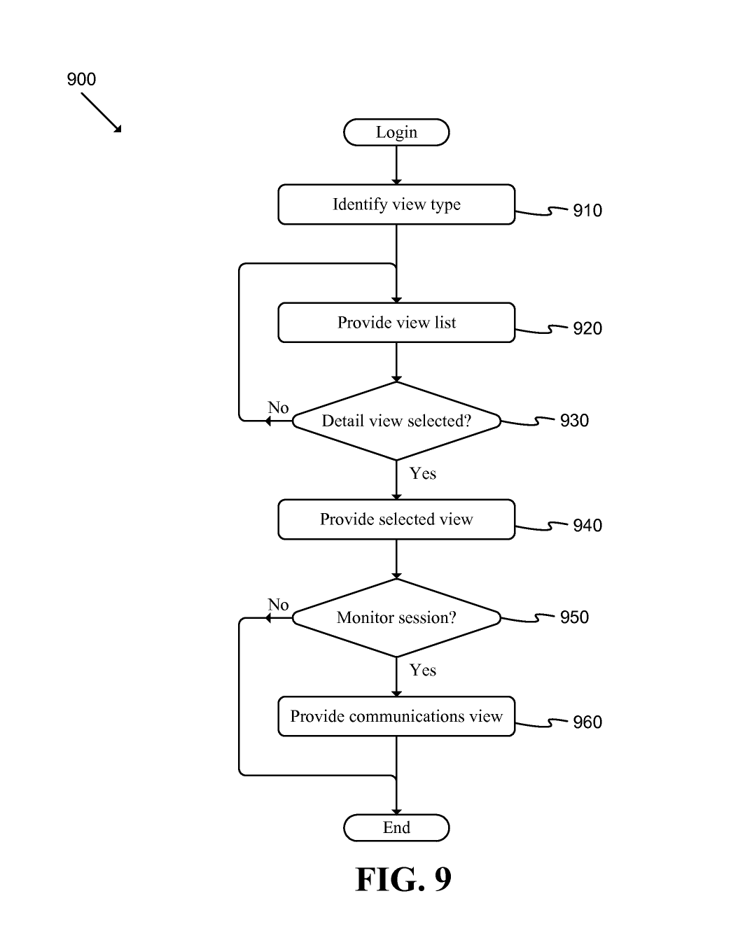

FIG. 9 illustrates a flow chart of a process 900 used by some embodiments to interact with an administrator-user. The process may be implemented using systems such as systems 100-300 described above. The process is one example of a user type-specific workflow described above in reference to operation 660. The workflow may be associated with an administrator or other privileged user. Such a process may begin, for instance, after a login process has been completed.

As shown, the process may identify (at 910) a view type (e.g., session, student, coach, etc.). Such a view type may be based one or more selections received from the administrator.

Next, the process may provide (at 920) the appropriate view list (e.g., sessions lists, students list, coaches list, etc.) based on a least partly on a view type.

The process may then determine (at 930) whether a detail view has been selected. If the process determines that a detail view has been selected, the process may provide (at 940) the selected view. Such a view may include, for instance, a session details view, a user detail view, etc.).

The process may then determine (at 950) whether to monitor a session. If the process determines that the administrator wishes to monitor a session, the process may provide (at 960) a communication view similar to that provided to a student or instructor. The communications view may include only one-way communication (e.g., the administrator is able to view content but not able to interact with the other users) or two-way communication, as appropriate. The communication view may utilize a video service and/or other external resources.

After determining (at 950) not to monitor a session or after providing (at 960) the communications view, the process may end.

One of ordinary skill in the art will recognize that process 900 may be implemented in various different ways without departing from the spirit of the invention. For instance, different embodiments may include different specific operations, eliminate various operations, merge or divide various operations, perform sets of operations iteratively, etc. In addition, the process may be performed as a set of sub-processes or included as part of a larger macro-process.

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

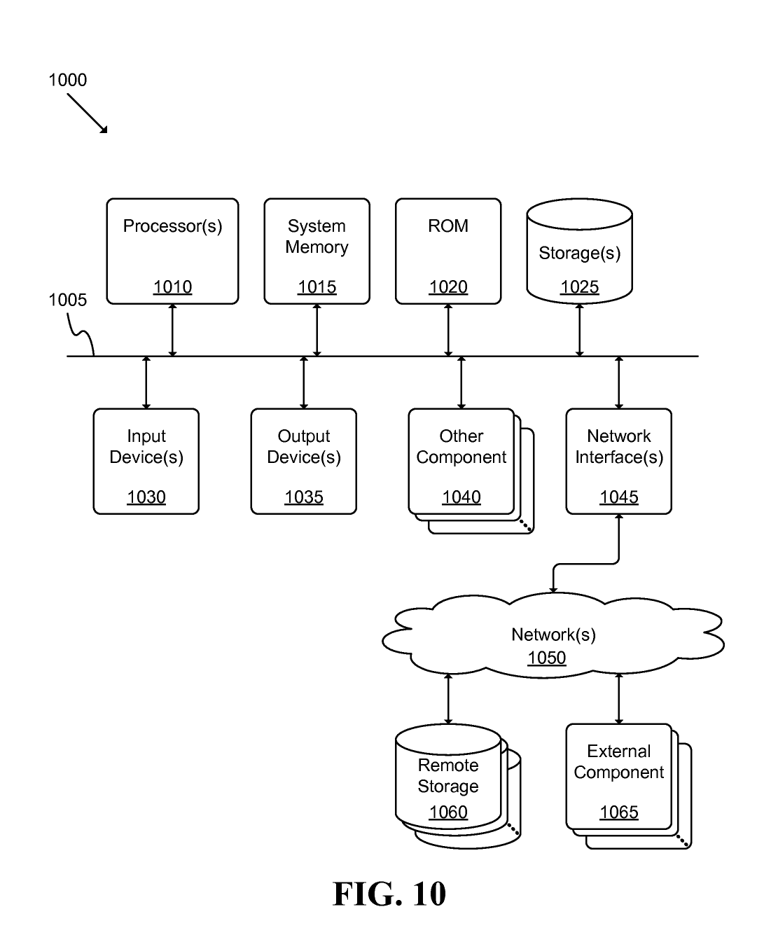

FIG. 10 illustrates a schematic block diagram of a computer system 1000 used to implement some embodiments. For example, the systems described above in reference to FIGS. 1-3 may be at least partially implemented using computer system 1000. As another example, the processes described in reference to FIGS. 4-9 may be at least partially implemented using sets of instructions that are executed using computer system 1000.

Computer system 1000 may be implemented using various appropriate devices. For instance, the computer system may be implemented using one or more personal computers (PCs), servers, mobile devices (e.g., a smartphone), tablet devices, and/or any other appropriate devices.

The various devices may work alone (e.g., the computer system may be implemented as a single PC) or in conjunction (e.g., some components of the computer system may be provided by a mobile device while other components are provided by a tablet device).

As shown, computer system 1000 may include at least one communication bus 1005, one or more processors 1010, a system memory 1015, a read-only memory (ROM) 1020, permanent storage devices 1025, input devices 1030, output devices 1035, various other components 1040 (e.g., a graphics processing unit), and one or more network interfaces 1045.

Bus 1005 represents all communication pathways among the elements of computer system 1000. Such pathways may include wired, wireless, optical, and/or other appropriate communication pathways. For example, input devices 1030 and/or output devices 1035 may be coupled to the system 1000 using a wireless connection protocol or system.

The processor 1010 may, in order to execute the processes of some embodiments, retrieve instructions to execute and/or data to process from components such as system memory 1015, ROM 1020, and permanent storage device 1025. Such instructions and data may be passed over bus 1005.

System memory 1015 may be a volatile read-and-write memory, such as a random access memory (RAM). The system memory may store some of the instructions and data that the processor uses at runtime. The sets of instructions and/or data used to implement some embodiments may be stored in the system memory 1015, the permanent storage device 1025, and/or the read-only memory 1020. ROM 1020 may store static data and instructions that may be used by processor 1010 and/or other elements of the computer system.

Permanent storage device 1025 may be a read-and-write memory device. The permanent storage device may be a non-volatile memory unit that stores instructions and data even when computer system 1000 is off or unpowered. Computer system 1000 may use a removable storage device and/or a remote storage device as the permanent storage device.

Input devices 1030 may enable a user to communicate information to the computer system and/or manipulate various operations of the system. The input devices may include keyboards, cursor control devices, audio input devices and/or video input devices. Output devices 1035 may include printers, displays, and/or audio devices. Some or all of the input and/or output devices may be wirelessly or optically connected to the computer system.

Other components 1040 may perform various other functions. These functions may include performing specific functions (e.g., graphics processing, sound processing, etc.), providing storage, interfacing with external systems or components, etc.

Finally, as shown in FIG. 10, computer system 1000 may be coupled to one or more networks 1050 through one or more network interfaces 1045. For example, computer system 1000 may be coupled to a web server on the Internet such that a web browser executing on computer system 1000 may interact with the web server as a user interacts with an interface that operates in the web browser. Computer system 1000 may be able to access one or more remote storages 1060 and one or more external components 1065 through the network interface 1045 and network 1050. The network interface(s) 1045 may include one or more application programming interfaces (APIs) that may allow the computer system 1000 to access remote systems and/or storages and also may allow remote systems and/or storages to access computer system 1000 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1000 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the spirit and scope of the disclosure as defined by the following claims.

I claim:

1. An automated method for providing real-time interactive athletic instruction, the method comprising:
receiving, at a server, multimedia content from a first user device associated with a student-user;
providing the multimedia content from the server to a second user device associated with an instructor-user; and
receiving, at the server, feedback from the second user device and providing the feedback from the server to the first user device.

2. The automated method of claim 1, wherein the multimedia content comprises video content captured by the first user device.

3. The automated method of claim 1, wherein the feedback comprises multimedia content captured by the second user device.

4. The automated method of claim 1 further comprising storing, at the server, the multimedia content and the feedback.

5. The automated method of claim 4 further comprising sending the stored multimedia content and feedback to a third user device associated with a third user.

6. The automated method of claim 1 further comprising sending a first notification via the first user device to the student-user and sending a second notification via the second user device to the instructor-user.

7. The automated method of claim 1 wherein the first user device comprises a camera and a display screen.

8. An automated method for reviewing athletic instruction, the method comprising:
receiving, at a server, a selection of a lesson from a user device;
retrieving, from a storage associated with the server, the selected lesson; and
sending, from the server to the user device, the selected lesson.

9. The automated method of claim 8, wherein the selected lesson comprises multimedia content.

10. The automated method of claim 9, wherein the multimedia content comprises content captured from a user device associated with a particular student-user and content captured from a user device associated with a particular instructor-user.

11. The automated method of claim 8 further comprising providing, from the server to the user device, a list of available lessons.

12. The automated method of claim 8 further comprising receiving feedback from the user device, wherein the feedback comprises a rating of at least one of the selected lesson and an instructor-user associated with the lesson.

13. The automated method of claim 8 further comprising receiving and storing journal data from the user device.

14. The automated method of claim 8 further comprising determining a user type associated with the user device.

15. A real-time interactive athletic instruction application comprising sets of instructions for:
receiving student login information;
providing a list of available instructors;
receiving a selection of an instructor; and
receiving a selection of a lesson start time.

16. The real-time interactive athletic instruction application of claim 15 further comprising sets of instructions for:
determining that the lesson start time is within a specified threshold;
sending a notification to the instructor; and
sending a notification to the student.

17. The real-time interactive athletic instruction application of claim 15 further comprising sets of instructions for:
providing an interactive lesson environment;
capturing data associated with the student;
capturing data associated with the instructor; and
storing the captured data to a server.

18. The real-time interactive athletic instruction application of claim 17 further comprising sets of instructions for:
receiving a selection of a stored lesson; and
providing captured data associated with the stored lesson.

19. The real-time interactive athletic instruction application of claim 17, wherein the captured data associated with the student comprises video data.

20. The real-time interactive athletic instruction application of claim 17, wherein the captured data associated with the instructor comprises multimedia data.
